(19) United States
(12) Patent Application Publication
(10) Pub. No.: US 2016/0117004 A1
(43) Pub. Date: Apr. 28, 2016

(54) FUNCTIONAL SINGLE-LAYER FILM AND DISPLAY DEVICE HAVING THE SAME

(71) Applicant: LG DISPLAY CO., LTD., Seoul (KR)

(72) Inventors: DongChin LEE, Seoul (KR); Chul-Hong KIM, Goyang-si (KR); Sunghee CHO, Seoul (KR); Keunyoung KIM, Seoul (KR); Yongbin JEONG, Seoul (KR); Kelly Sooyeun SONG, Paju-si (KR)

(21) Appl. No.: 14/856,170

(22) Filed: Sep. 16, 2015

(30) Foreign Application Priority Data
Oct. 22, 2014 (KR) 10-2014-0143141

(51) Int. Cl. G06F 3/041; B32B 17/06; B32B 27/06; C08J 5/18

(52) U.S. Cl. CPC G06F 3/041; C08J 5/18; B32B 17/06; B32B 27/06; C08J 2300/00; B32B 2255/20; B32B 2457/208; B32B 2264/108

(57) ABSTRACT

Disclosed are a functional single-layer film and a display device including the same. The functional single-layer film is positioned on a cover window of the display device. The functional single-layer film includes a matrix material and carbon-containing flakes contained in the matrix material. The content of the carbon-containing flakes ranges from 0.01% to 0.1% by weight.

### CROSS REFERENCE TO RELATED APPLICATION

This application claims priority from and the benefit under 35 U.S.C. §119(a) of Korean Patent Application Number 10-2014-0143141 filed on Oct. 22, 2014, which is hereby incorporated by reference for all purposes as if fully set forth herein.

### BACKGROUND

1. Field of Art

The present invention relates to a functional single-layer film and a display device having the same.

2. Description of the Related Art

Graphene, a two-dimensional material formed of an sp2 carbon network having the thickness of a single carbon atom, has received interest from a number of scientists for a long period of time. In 2004, Dr. Andre Geim and Dr. Konstantin Novoselov first extracted graphene from graphite in a simple manner using Scotch tape, and reported the superior electrical properties of graphene. Since then, the applications of graphene-based materials in several areas including transistors, transparent electrodes, energy storage materials (capacitors having super-high capacity, secondary cells, hydrogen storage materials, etc.), sensors, polymer complexes, and the like have been studied.

In addition, in response to the development of the information society, there is increasing demand for various types of display devices able to display images. Currently, various display devices, such as liquid crystal displays (LCDs), plasma display panels (PDPs) and organic light-emitting diode (OLED) display devices, are used.

A multilayer protective film may be positioned on a cover window used in a display device of the related art. Anti-reflection, anti-fingerprint, antibacterial, and high-strength characteristics are required in the protective film.

However, the protective film of the related art is somewhat problematic, in that all of the anti-reflection, anti-fingerprint, antibacterial, and high-strength characteristics cannot be simultaneously realized. In addition, the multilayer structure of the protective film causes the problems of increased reflectance due to interface reflection as well as increases in the number of process steps and the time required for processing. Furthermore, related-art materials allowing the antibacterial characteristics to be realized decrease light transmittance, degrade high-strength characteristics, and lower the reliability of the display device, all of which are problematic.

### SUMMARY

Various aspects of the present invention provide a functional single-layer film in which anti-reflection, anti-fingerprint, antibacterial, and high-strength characteristics are simultaneously realized, light transmittance and reflectance characteristics and reliability as well as the anti-reflection, anti-fingerprint, antibacterial, and high-strength characteristics are improved, the time required for processing and manufacturing costs are reduced, and a display device having the same.

In an aspect of the present invention, provided is a functional single-layer film positioned on a cover window of a display device. The functional single-layer film includes a matrix material and carbon-containing flakes contained in the matrix material. The content of the carbon-containing flakes ranges from 0.01% to 0.1% by weight of the functional single-layer film.

In another aspect of the present invention, provided is a display device including a display panel, a cover window positioned on the display panel, and a functional single-layer film positioned on the cover window. The functional single-layer film includes a matrix material and carbon-containing flakes contained in the matrix material. The content of the carbon-containing flakes ranges from 0.01% to 0.1% by weight of the functional single-layer film.

In a further aspect of the present invention, provided is a display device including a base layer and a functional single-layer film positioned on the base layer. The functional single-layer film includes a matrix material and carbon-containing flakes contained in the matrix material.

The functional single-layer film and the display device having the same according to the present invention have improvements in anti-reflection, anti-fingerprint, antibacterial, high-strength, light transmittance, and reflectance characteristics and reliability.

In addition, the functional single-layer film and the display device having the same simultaneously realize the anti-reflection, anti-fingerprint, antibacterial, and high-strength characteristics, and reduce the time required for processing and manufacturing costs.

### BRIEF DESCRIPTION OF THE DRAWINGS

The above and other objects, features and advantages of the present invention will be more clearly understood from the following detailed description when taken in conjunction with the accompanying drawings, in which:

FIG. 1A to FIG. 1C are schematic structural views illustrating examples of display devices to which various embodiments are applied;

FIG. 2 is a schematic cross-sectional view illustrating a typical protective film of a display device;

FIG. 3 is a schematic cross-sectional view illustrating a functional single-layer film of a display device according to an exemplary embodiment of the present invention;

FIG. 4A is a diagram illustrating an example of a method of manufacturing graphene oxide and reduced graphene oxide;

FIG. 4B is a diagram illustrating a typical structure of graphene oxide;

FIG. 5 is a schematic cross-sectional view illustrating a functional single-layer film of a display device according to another exemplary embodiment of the present invention;

FIG. 6 illustrates the scattering of external light in a functional single-layer film of a display device according to embodiments of the present invention;

FIG. 7 illustrates the contact angle of water on the surface of the functional single-layer film of the display device according to embodiments of the present invention;

FIG. 8 illustrates an antibacterial function in the functional single-layer film of the display device according to embodiments of the present invention;

FIG. 9A and FIG. 9B are tables presenting the physical properties of typical protective films of a display device;

FIG. 10 is a table presenting the physical properties of a functional single-layer film of a display device according to embodiments of the present invention;

FIG. 11 is a table presenting antibacterial functions according to the thickness of graphene oxide contained in a functional single-layer film of a display devices according to embodiments of the present invention;

FIG. 12A and FIG. 12B are a graph and table presenting the amount of reactive oxygen species (ROS) produced from a typical protective film of a display device and a functional single-layer film of a display device according to embodiments of the invention; and

FIG. 13 is a graph illustrating the effects of a functional single-layer film of a display device according to various embodiments against yellow Staphylococcus aureus.

### DETAILED DESCRIPTION OF THE EXEMPLARY EMBODIMENTS

Hereinafter, a few embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order sequence or number of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

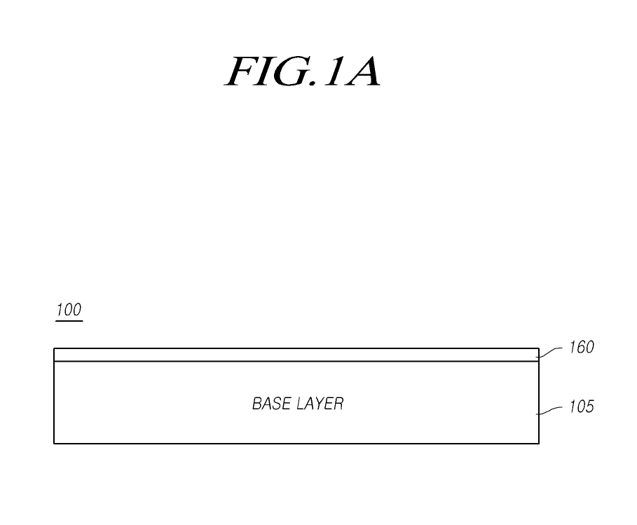

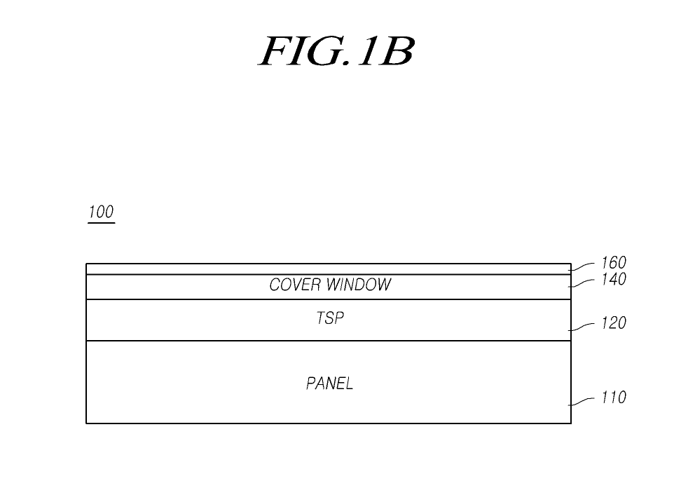

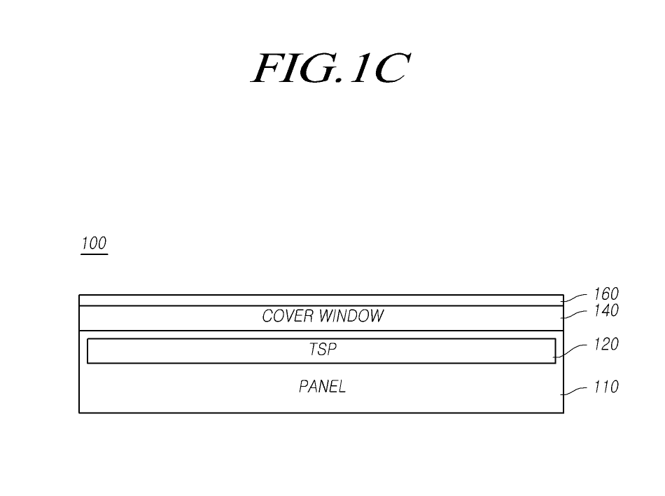

FIG. 1A to FIG. 1C are schematic structural views illustrating examples of display devices to which various embodiments are applied.

Referring to FIG. 1A to FIG. 1C, a display device 100 includes a base layer 105 and a functional single-layer film 160 disposed on the base layer 105. The functional single-layer film 160 includes a matrix material (not shown) and carbon-containing flakes (not shown) contained in the matrix material (not shown).

In this case, the base layer 105 may be a display panel 110 of the display device 100, a touchscreen panel (TSP) 120 of the display device 100, or a cover window 140 of the display device. However, the applications of the base layer 105 are not limited thereto.

Although the functional single-layer film 160 will be described as being positioned on the cover window 140 in the following, this is merely for the sake of explanation. It should be understood that the functional single-layer film 160 according to embodiments may be positioned on the display panel 110 or the touchscreen panel 120 in the absence of the cover window 140.

The content of the carbon-containing flakes (not shown) may range from 0.01% to 0.1% of the total weight of the functional single-layer film 160.

The display device 100 may be a liquid crystal display (LCD) device, an organic light-emitting diode (OLED) display device, or a plasma display panel (PDP) device. The display panel 110 may be an LCD panel of the LCD device, an OLED display panel of the OLED display device, or a PDP display panel of the PDP device. However, the present invention is not limited thereto.

Specifically, the display device 100 includes the display panel 110, the cover window 140 positioned on the display panel 110, and the functional single-layer film 160 positioned on the cover window 140. The functional single-layer film 160 includes a matrix material (not shown) and carbon-containing flakes (not shown) contained in the matrix material (not shown). The content of the carbon-containing flakes (not shown) may range from 0.01% to 0.1% of the total weight of the functional single-layer film 160.

The carbon-containing flakes (not shown) may be at least one type of flakes selected from among graphene flakes, graphene oxide flakes and reduced graphene oxide flakes.

In addition, the refractive index of the carbon-containing flakes (not shown) is greater than the refractive index of the matrix material (not shown). This characteristic allows light entering from the outside to be scattered, whereby anti-reflection characteristics are realized and visibility is improved.

The carbon-containing flakes (not shown) are uniformly dispersed in the matrix material (not shown). Accordingly, the anti-reflection, anti-fingerprint and antibacterial characteristics of the functional single-layer film 160 can be realized uniformly over the entire surface.

For this, the matrix material (not shown) must be a material having superior ability to disperse the carbon-containing flakes (not shown), and may be, for example, a siloxane polymer resin or a urethane polymer resin.

The matrix material (not shown) may further include a hydrophobic material in addition to the carbon-containing flakes (not shown). Accordingly, the anti-fingerprint characteristics of the functional single-layer film 160 are further enhanced.

The touchscreen panel 120 may be an add-on touchscreen panel positioned on the display panel 110 (see FIG. 1B) or an on-cell or in-cell touchscreen panel disposed inside the display panel 110 (see FIG. 1C). The on-cell touchscreen panel is formed on the same cell as a liquid crystal layer of the LCD panel or an organic layer of the OLED display panel, whereas the in-cell touchscreen panel is formed together with the cell.

The cover window 140 is positioned on the display panel 110 or the touchscreen panel 120. The cover window 140 is a cover protecting the display surface of the display panel 110. The cover window 140 may be formed of, for example, glass or high light transmittance plastic. However, the present invention is not limited thereto.

The functional single-layer film 160 is positioned on the cover window 140. According to these embodiments, the functional single-layer film 160 of the display device 100 includes a matrix material (not shown) and carbon-containing flakes (not shown) dispersed in the matrix material (not shown).

This functional single-layer film 160 prevents the degradation of visibility, such as luminance or contrast ratio, by reducing the reflection of light entering from the outside, has an anti-fingerprint effect, and at the same time, performs an antibacterial function to kill foreign bacteria or the like. In addition, the functional single-layer film 160 has high-hardness characteristics due to the rigidity of the carbon-containing flakes. Detailed descriptions of these effects will be given below in the sections related to the corresponding figures.

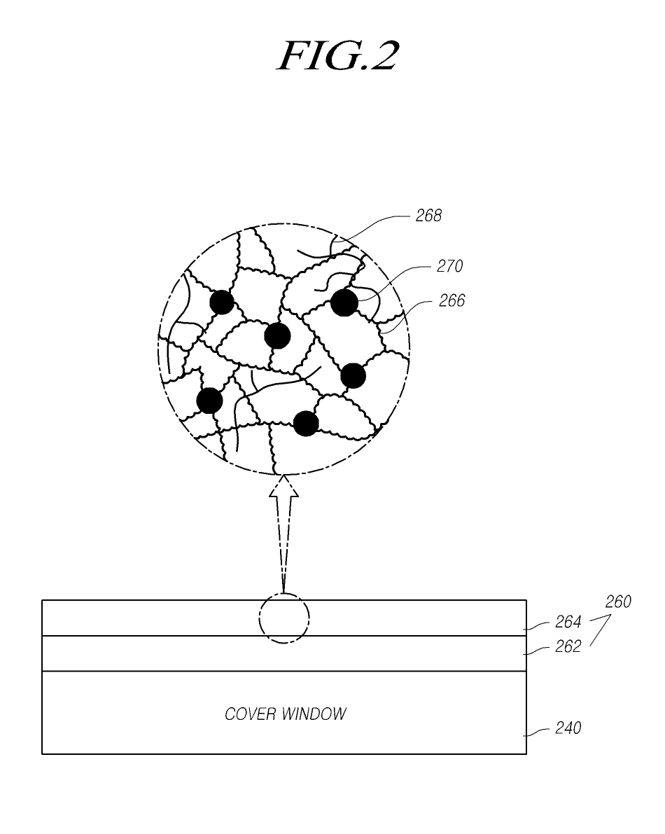

FIG. 2 is a schematic cross-sectional view illustrating a typical protective film of a display device.

Referring to FIG. 2, a typical display device 100 includes a cover window 240 positioned on the base layer 105 and a protective film 260 formed on the cover window 240.

The protective film 260 includes a first protective film 262 and a second protective film 264. The first protective film 262 may be an antibacterial layer, whereas the second protective film 264 may be a layer having anti-reflection and anti-fingerprint characteristics.

Specifically, the first protective film 262 may be formed of, for example, silver (Ag), zinc oxide (ZnO), or titanium oxide (TiO₂). However, such materials having an antibacterial function can be applied only as a lower coating film since they have relatively weak surface strength. Considering bacteria or germs typically come from the outside and the part of the display device 100 that a user directly touches is the outermost layer, a substantial antibacterial function cannot be expected.

In particular, when the first protective film 262 is formed of ZnO, solution processing is impossible, elution lowers reliability, and light generated from the interior of the panel 110 has a yellowish color while passing through the first protective film 262 formed of ZnO. In addition, when the first protective film 262 is formed of Ag, the use of Ag is problematic since Ag is relatively expensive.

As illustrated in the enlarged part in FIG. 2, the second protective film 264 includes a first polymer 266, a second polymer 268, and nanoparticles 270.

The first polymer 266 serves to form the skeletal structure of the second protective film 264 while maintaining rigidity. The second polymer 268 may be formed of a hydrophobic material, and performs an anti-fingerprint function.

The nanoparticles 270 may be formed of a high-refractivity material, for example, silicon dioxides (SiO2). The nanoparticles function to scatter light entering from the outside.

The protective film 260 may be formed of a multiplicity of substances. However, it is difficult to either mix these substances or achieve a uniform effect across the entire surface of the protective film 260, and the multilayer structure of the protective film 260 increases the number of process steps and the time required for processing. Furthermore, the multilayer structure may cause external light to be reflected at the interlayer interface, and this interface reflection may lower visibility.

Due to the weak surface strength or hardness of the first protective film 262 having an antibacterial function, the reliability of the display device 100 is lowered. Since the first protective film 262 is an underlying layer, the first protective film 262 may provide substantially no antibacterial function, which is problematic. In addition, light transmittance is reduced by the particles of the first protective film 262, thereby lowering luminance or contrast characteristics. Furthermore, when the antibacterial material is formed of titanium oxide (TiO₂), harmful reactive oxygen species (ROS) may be produced.

In order to avoid such problems that may occur when the protective film 260 is formed as a multilayer structure, a single layer is formed by adding the antibacterial material of the first protecting film 262 to the second protective film 264. In this case, however, the corresponding materials do not uniformly mix, the light transmittance, anti-reflection, and antibacterial characteristics are lowered. In other words, the anti-reflection, light transmittance, anti-fingerprint, and antibacterial characteristics may be in a trade-off relationship, i.e. it is difficult to realize all of these characteristics simultaneously.

Detailed descriptions will be given below of embodiments able to overcome the above-mentioned problems with reference to the drawings.

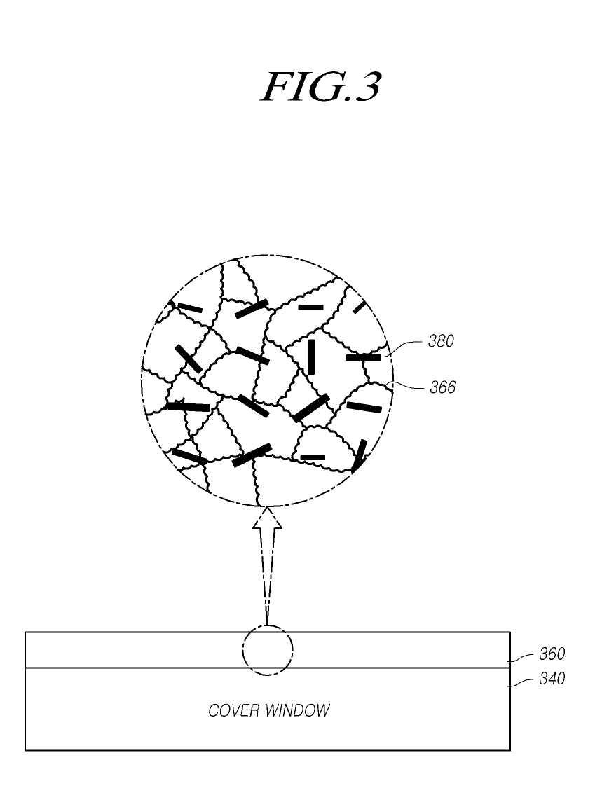

FIG. 3 is a schematic cross-sectional view illustrating a functional single-layer film of a display device according to an exemplary embodiment of the present invention.

Referring to FIG. 3, a display device 100 includes a cover window 340 positioned on the base layer 105, such as the display panel 110 or the touchscreen panel 120, and a functional single-layer film 360 positioned on the cover window 340.

The functional single-layer film 360 includes a matrix material 366 and carbon-containing flakes 380 contained in the matrix material 366. The amount of the carbon-containing flakes 380 may range from 0.01% to 0.1% by weight of the total mass of the functional single-layer film 360.

The functional single-layer film 360 is formed by coating the cover window 340 with the matrix material 366, which is liquid at room temperature, and contains the carbon-containing flakes 380, and subsequently curing the matrix material 366 by applying ultraviolet (UV) radiation or heat thereto.

Here, the matrix material 366 forms the skeletal structure of the functional single-layer film 360, maintains the strength or hardness of the functional single-layer film 360, and contains the carbon-containing flakes 380 by dispersing the carbon-containing flakes 380 therein. This matrix material 366 may be formed of a polymer resin, for example, a photo-curing or thermosetting polymer resin selected from among siloxanes, urethanes, tri-acetyl-cellulose (TAC), polyester (PE), polyethylene terephthalate (PET), polyethylene naphthalate (PEN), oriented polypropylene (PP), polycarbonate (PC), acryls, epoxies, melamines, and silicones. However, the present invention is not limited thereto, but the matrix material 366 may be any material that has high-hardness characteristics and ability to disperse the carbon-containing flakes 380 therein. In particular, since urethane polymer resins have superior mechanical flexibility, they can be used in the display device 100 that is flexible.

The carbon-containing flakes 380 may be at least one type of flakes selected from among graphene flakes, graphene oxide flakes, and reduced graphene oxide flakes.

The carbon-containing flakes 380 realize the anti-reflection, anti-fingerprint, and antibacterial characteristics of the functional single-layer film 360.

Specifically, the refractive index (RI) of the carbon-containing flakes 380 may be greater than the refractive index of the matrix material 366. For example, the refractive index of the carbon-containing flakes formed of graphene may range from 2.3 to 2.6, whereas the refractive index of the matrix material 366 formed of a siloxane polymer material may range from 1.2 to 1.4. The difference in the refractive indices realizes the anti-reflection characteristics by scattering light entering from the outside, whereby the visibility degradation of a user attributable to the reflection of the external light is prevented.

According to an embodiment, the contact angle of water on the surface of the functional single-layer film 360 is 100° or greater, which is caused by the carbon-containing flakes 380. When the contact angle of a material is 90° or greater, this material may be defined as a hydrophobic material. Since the functional single-layer film 360 containing the carbon-containing flakes 380 is also hydrophobic, the anti-fingerprint characteristics able to remove hydrophilic materials or hydrophilic contaminants are realized.

In order to enhance the hydrophobic characteristics, the functional single-layer film 360 may further include a hydrophobic fluorine polymer.

For example, when the carbon-containing flakes 380 are graphene flakes, the functional single-layer film 360 including the carbon-containing flakes 380 formed of graphene has the antibacterial characteristics. Specifically, the carbon-containing flakes 380 formed of graphene, for example, kill germs (bacteria) not only by penetrating into and cutting the membranes of germs (bacteria), but also by extracting a large amount of phospholipid molecules on the membranes.

The carbon-containing flakes 380 can also improve the light transmittance, hardness and reliability of the functional single-layer film 360. For example, the thickness of each of the carbon-containing flakes 380 formed of graphene is 2 nm or less, and the light transmittance of the functional single-layer film 360 including the carbon-containing flakes 380 formed of graphene in the shape of an ultra-thin film may be 90% or higher. In addition, in the functional single-layer film 360, the carbon-containing flakes 380 formed of graphene improve the hardness or strength of the functional single-layer film 360, since the carbon-containing flakes 380 have high-hardness characteristics. Furthermore, when the functional single-layer film 360 is applied to the flexible display device 100, superior reliability can be realized. That is, ability to withstand continuously repeated folding and bending is realized.

The carbon-containing flakes 380 may be uniformly dispersed or distributed inside the matrix material 360. Accordingly, the anti-reflection, anti-fingerprint, antibacterial, high-transmittance, high-hardness, and high-reliability characteristics can be realized uniformly over the entire surface of the functional single-layer film 360.

While the protective film 260 of the related art cannot simultaneously realize all of the anti-reflection, anti-fingerprint, and antibacterial characteristics, the functional single-layer film 360 and the display device 100 including the same according to embodiments simultaneously realize these characteristics.

Such effects due to the carbon-containing flakes 380 can be maximized when the content of the carbon-containing flakes 380 ranges from 0.01% to 0.1% by weight of the total mass of the functional single-layer film 360 of the display device 100.

When the content of the carbon-containing flakes 380 is less than 0.01% by weight, the anti-reflection, anti-fingerprint, antibacterial, high-transmittance, high-hardness, and high-reliability characteristics are insignificant or cannot be expected. On the other hand, the content of the carbon-containing flakes 380 greater than 0.1% by weight increases the reflection of external light, decreases light transmittance, and resultantly increases haze (hazing). Accordingly, the functional single-layer film 360 according to embodiments may include the carbon-containing flakes 380 at an amount ranging from 0.01% to 0.1% by weight.

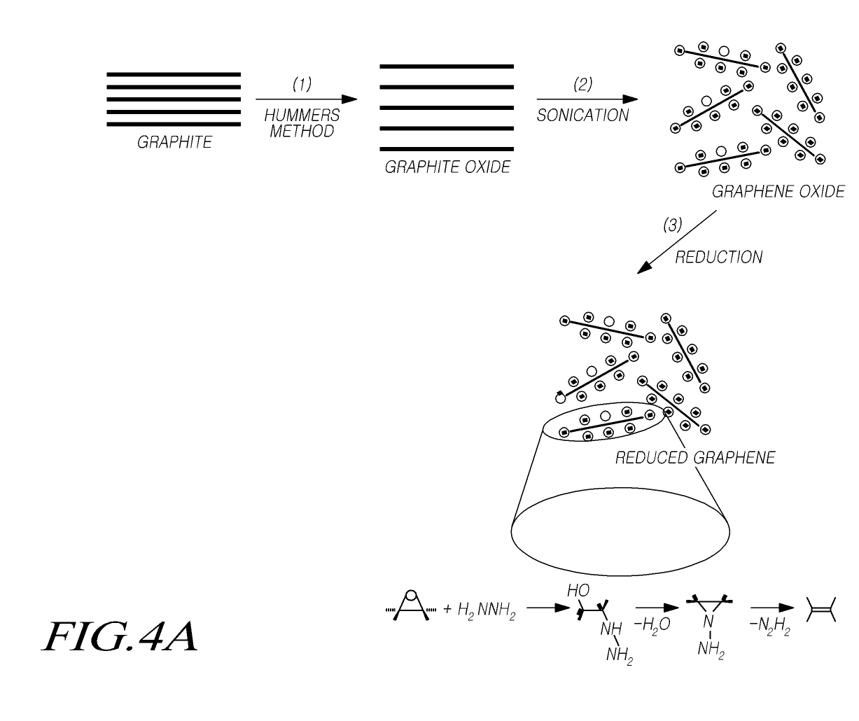

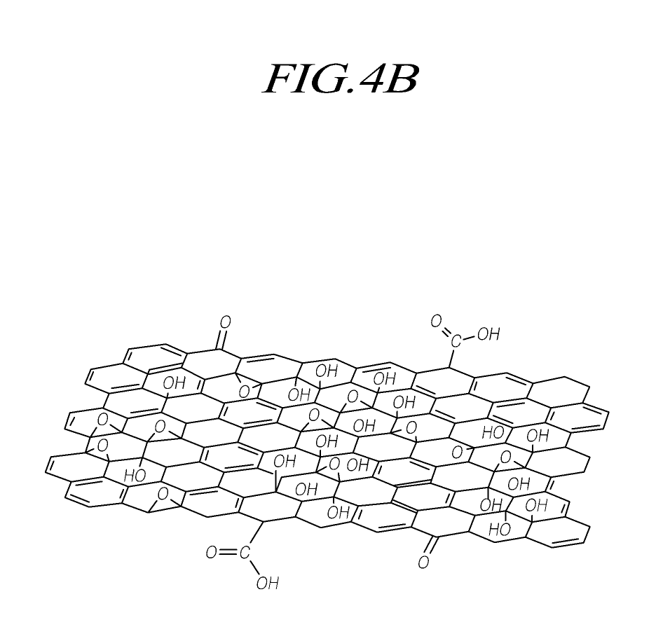

FIG. 4A is a diagram illustrating an example of a method of manufacturing graphene oxide and reduced graphene oxide, and FIG. 4B is a diagram illustrating a typical structure of graphene oxide.

As described above, the carbon-containing flakes 380 may be one type of flakes selected from among, for example, graphene flakes, graphene oxide flakes, and reduced graphene oxide flakes. However, it should be understood that this is merely for the sake of explanation, and the carbon-containing flakes 380 may be formed of any other material.

The method of manufacturing graphene oxide and reduced graphene oxide illustrated in FIG. 4A is described in an illustrative manner for the sake of explanation, but graphene oxide and reduced graphene oxide can be manufactured by a variety of manufacturing methods without being limited thereto.

Referring to FIG. 4A, graphite is converted into graphite oxide by Hummer's method as indicated by (1).

Specifically, it is possible to oxidize the graphite to the graphite oxide using potassium permanganate (KMnO4) and sulfuric acid (H2504). In addition to Hummer's method, the graphite oxide may be manufactured using potassium chlorate (KC1O3) and nitric acid (HNO3).

Thereafter, as indicated by (2), the graphite oxide is dispersed in water and alcohol through ultrasonic dispersion or sonication, thereby forming graphene oxide (GO). Here, a single layer of the dispersed graphite oxide is separated, thereby being transformed into graphene oxide.

Afterwards, as indicated by (3), the dispersed graphene oxide is converted into a thin film through spin coating or the like, and is subsequently reduced by a hydrazine reducer, whereby reduced graphene oxide (rGO) is synthesized.

The structure of the graphene oxide is illustrated in FIG. 4B. Since the graphene oxide includes a number of alcohol groups and a number of carboxyl groups, a variety of applications can be made by reacting these groups with functional groups of a different compound.

Although not shown in FIG. 4A, graphene may be manufactured by a variety of methods. For example, graphene may be mechanically peeled from graphite, may be formed on a metal catalyst by chemical vapor deposition, or may be formed on the surface of silicon carbide (SiC) that is decomposed by heating. In addition, it is possible to manufacture graphene oxide by oxidizing graphene produced in this manner, or form reduced graphene oxide by reducing graphene oxide.

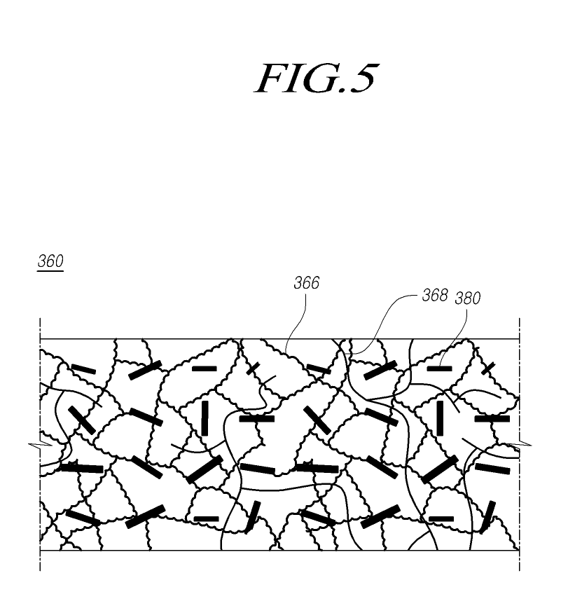

FIG. 5 is a schematic cross-sectional view illustrating a functional single-layer film of a display device according to another exemplary embodiment of the present invention.

Referring to FIG. 5, in the functional single-layer film 360 of the display device 100, the matrix material 366 further includes a hydrophobic material 368 in addition to the carbon-containing flakes 380.

For example, the hydrophobic material may be one selected from among, but is not limited to, a fluorine polymer, a silicon polymer, and a fluorine-silicon polymer. Fluorine and silicon components increase the hardness of a compound and lower the surface energy of the compound through bonding with another material. This can consequently improve the hydrophobic characteristics of the protective film, thereby improving the effect of removing contaminants from the functional single-layer film 360.

Detailed descriptions will be given below of the effects of the functional single-layer film 360 and the display device 100 according to various embodiments with reference to the drawings.

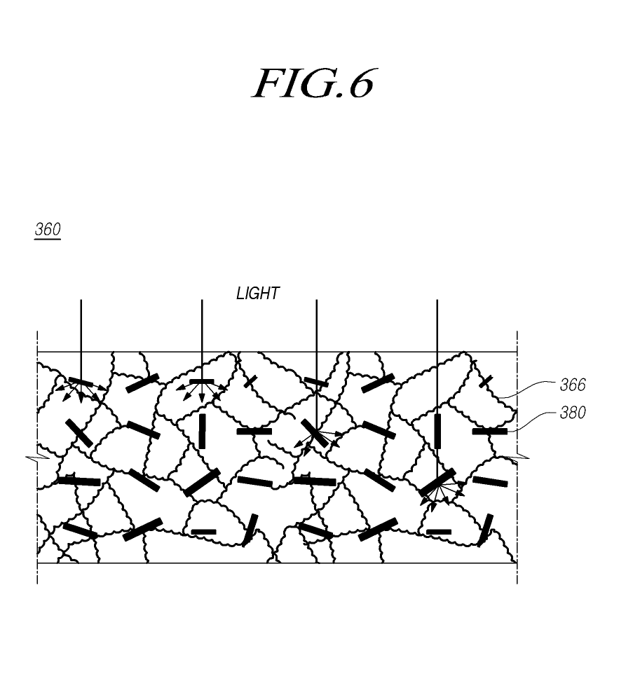

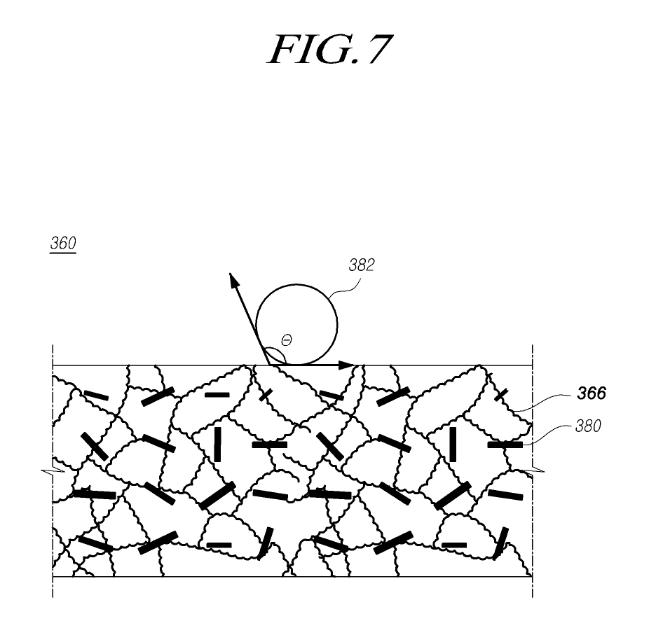

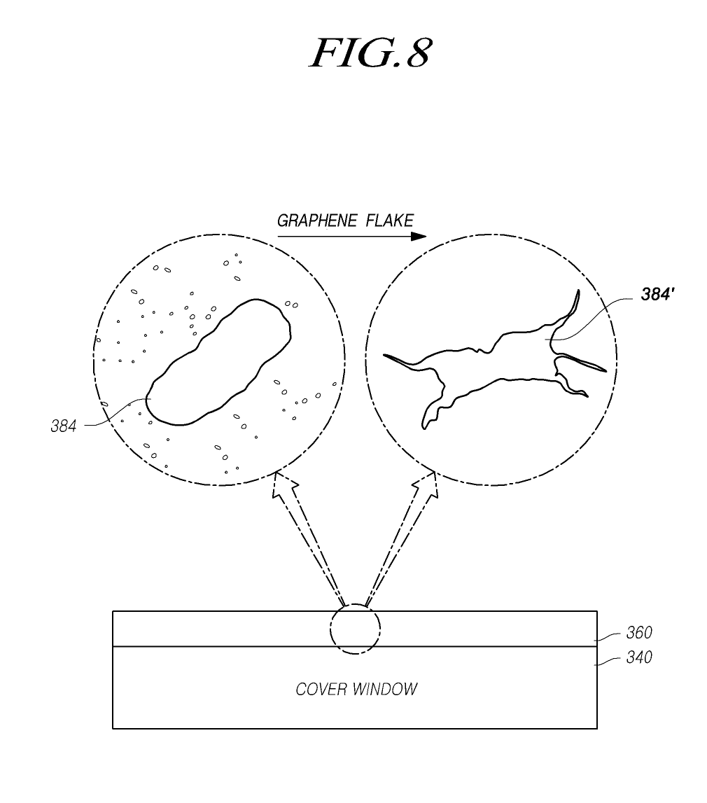

FIG. 6 illustrates the scattering of external light in a functional single-layer film of a display device according to embodiments of the present invention, FIG. 7 illustrates the contact angle of water on the surface of the functional single-layer film of the display device according to embodiments of the present invention, and FIG. 8 illustrates an antibacterial function in the functional single-layer film of the display device according to embodiments of the present invention.

Referring to FIG. 6, in the functional single-layer film 360, the refractive index (RI) of the carbon-containing flakes 380 may be greater than the refractive index of the matrix material 366. For example, the refractive index of the carbon-containing flakes 380 formed of graphene may range from 2.3 to 2.6, and the refractive index of the matrix material 366 formed of a siloxane polymer material may range from 1.2 to 1.4.

This difference in the refractive indices causes the scattering of external light, i.e. the external light collides into graphene particles and thus is reflected in several directions. The scattering is more significant with an increase in the difference in the refractive indices. Since the carbon-containing flakes 380 are a high-refractive-index material, the effect of preventing the visibility of a user from being decreased by the reflection of external light is realized.

Referring to FIG. 7, the contact angle of water (H₂O) 382 on the surface of the functional single-layer film 360 is greater than 90° owing to the carbon-containing flakes 380. In other words, the surface of the functional single-layer film 360 is hydrophobic, and the surface energy thereof is low.

It is therefore possible to prevent hydrophilic contaminants or fingerprints from sticking to the surface of the functional single-layer film 360. This property is referred to as anti-fingerprint characteristics, which can protect the cover window 340, the display panel 110, and the touchscreen panel 120 under the functional single-layer film 360 from the external environment.

Referring to FIG. 8, the carbon-containing flakes 380 have an antibacterial function to kill a bacterium 384 that touches the functional single-layer film 360 on the cover window 340. In other words, the bacterium 384 on the functional single-layer film 360 becomes a killed cell 384′.

When the carbon-containing flakes 380 are formed of graphene, graphene oxide, or reduced graphene oxide, the unique two-dimensional structure of graphene causes a strong interaction between graphene and phospholipid molecules on the bacterium cell. Consequently, a large amount of phospholipid molecules leave the cell membrane and are attached to the graphene surface, whereby the bacterium is killed. Accordingly, the display device including the functional single-layer film 360 and the user can be protected from harmful components.

While the typical protective film 260 of the display device did not simultaneously have all of the anti-reflection, anti-fingerprint, and antibacterial characteristics as described above, the functional single-layer film 360 according to various embodiments can simultaneously have all of these effects.

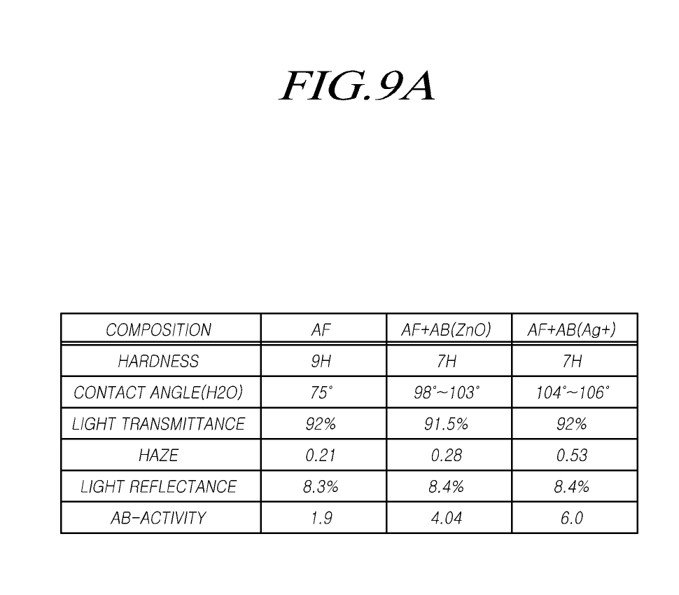

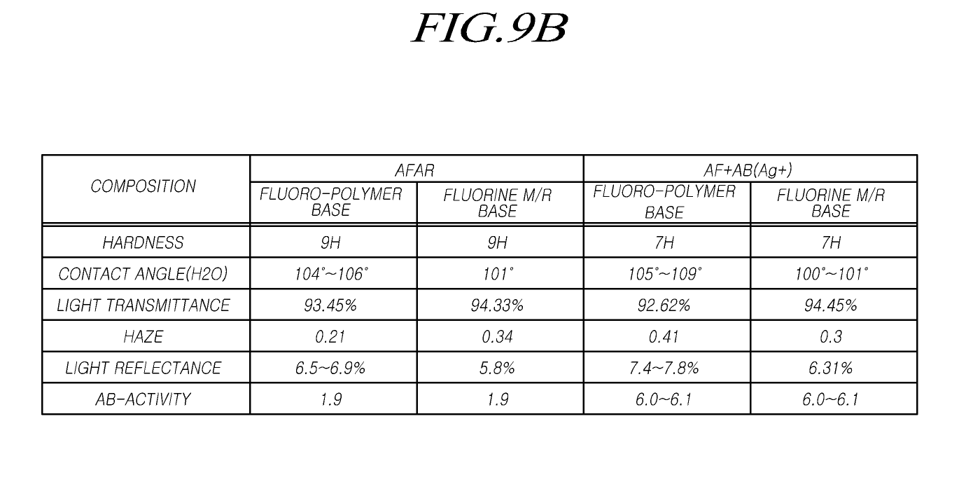

FIG. 9A and FIG. 9B are tables presenting the physical properties of typical protective films of a display device.

Hereinafter, in the specification and the drawings, “AR” refers to anti-reflection, “AF” refers to anti-fingerprint, and “AB” refers to antibacterial.

Referring to FIG. 2 and FIG. 9A, the table presents the physical properties of the protective films. In the column indicated by AF, the protective film 260 was formed of a single layer (AF) including the hydrophobic second polymer 268. In the column indicated by AF+AB(ZnO), the protective film 260 was formed including the second protective film 264 containing the second polymer 268 and the first protective film 262 containing zinc oxide (ZnO) as an antibacterial material. In the column indicated by AF+AB(Ag+), the protective film 260 was formed including the second protective film 264 containing the second polymer 268 and the first protective film 262 containing silver ions (Ag+) as an antibacterial material.

In the table, “Hardness” refers to the quality of being hard, which is expressed by a relative value. The greater the value is, the greater the hardness is. In addition, “Haze” refers to the size of a blurred area on the screen of the display device 100, which is expressed by a relative value.

In the table, “AB-activity” refers to antibacterial activity against Escherichia coli and Staphylococcus aureus measured in antimicrobial tests. The antimicrobial tests were performed according to JIS Z 2801:2006 (Antimicrobial Products: Test for antimicrobial activity and efficacy). The values of AB-activity (R) were calculated according to Formula 1 below. The term AB-activity has the same meaning throughout the following drawings.

AB−activity=antibacterial activity(R)=[log(B/A)/log(C/A)]=[log(B/C)] [Formula 1]

In Formula 1, A is an average of viable cell counts in a non-processed sample just after inoculation, B is an average of viable cell counts in the non-processed sample after 24 hours, and C is an average of viable cell counts in a sample 24 hours after antibacterial processing.

In the non-processed sample, the protective film 260 was formed of only the first polymer 266. In the antibacterial-process sample, the composition of the protective film 260 included materials required for individual components.

Referring to the table illustrated in FIG. 9A, in the protective film 260 including the antibacterial first protective film 262, the hardness was reduced, and the haze (hazing), i.e. the state in which the screen is blurred, was increased. These characteristics were caused by the weak hardness or strength of zinc oxide (ZnO) and silver (Ag) and light scattered or reflected by ZnO and Ag particles.

Although not presented in the table, when the protective film 260 has a bilayer structure, there are problems in that the number of processing steps increases, and the time required for processing increases, thereby increasing manufacturing costs.

Referring to FIG. 2 and FIG. 9B, the table presents the physical properties of the protective films. In the column indicated by AFAR, the protective film 260 was formed of a single layer including the second polymer 268 and silicon oxide (SiO₂) as the anti-reflection nanoparticles 270. In the column indicated by AF+AB(Ag+), the protective film 260 was formed of a single layer including the second polymer 268, silicon oxide (SiO₂) as the anti-reflection nanoparticles 270, and silver ions (Ag+) as an antibacterial material.

In the table, “Fluoro-polymer base” indicates a linear arrangement of the second polymer 268 including fluorine, and “Fluorine M/R base” indicates a pyramidal arrangement of the second polymer 268 including fluorine. Differences in the physical properties between the two types were very insignificant.

Referring to the table, when silver ions (Ag+) were added as an antibacterial material, hardness was significantly reduced.

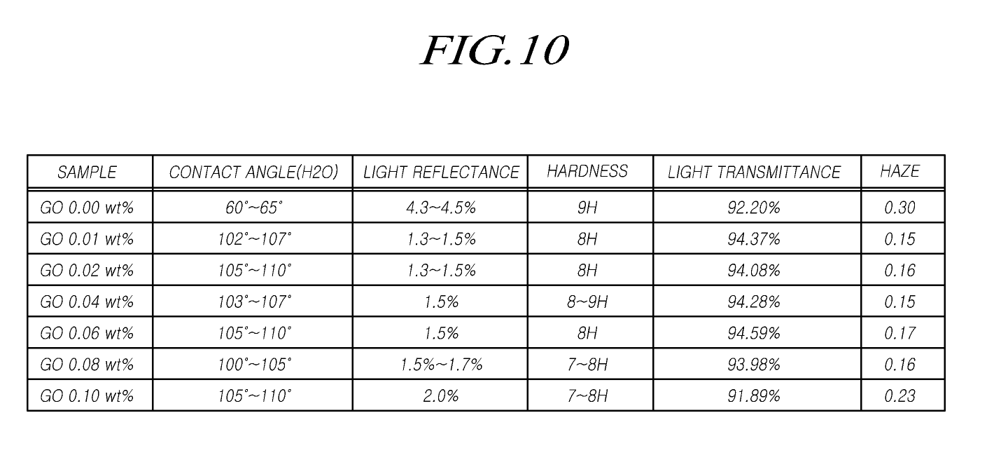

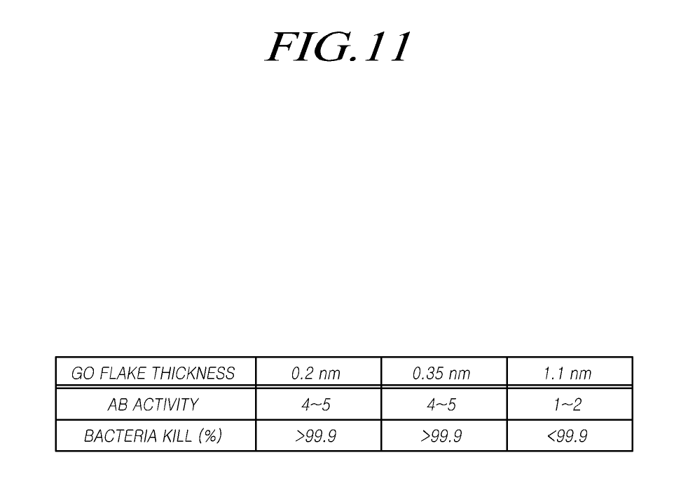

FIG. 10 is a table presenting the physical properties of a functional single-layer film used in a display device according to embodiments of the present invention, and FIG. 11 is a table presenting antibacterial functions according to the thickness of graphene oxide contained in a functional single-layer film of a display devices according to embodiments of the present invention.

Referring to FIG. 3 and FIG. 10, the table illustrated in FIG. 10 presents physical properties according to the contents of the carbon-containing flakes 380 formed of graphene oxide. The matrix material 366 was implemented as a siloxane polymer resin.

Compared to the functional single-layer film 380 formed of only the matrix material 366, when the carbon-containing flakes 380 formed of graphene oxide were included, the contact angle of water was significantly increased (exceeding 100°), light reflectance was significantly decreased (1.3% to 2.0%), light transmittance was significantly increased (93% to 94%), and haze (hazing) was reduced (0.15 to 0.23). It is apparent that hardness was not significantly decreased.

These results indicate that the functional single-layer film 380 can simultaneously improve the anti-reflection, anti-fingerprint, light transmittance, and visibility characteristics.

Referring to FIG. 11, antibacterial functions of about 99.9% or greater were observed regardless of the thickness of the carbon-containing flakes 380 formed of graphene oxide contained or impregnated in the matrix polymer 366 formed of a siloxane polymer resin.

As apparent from FIG. 10 and FIG. 11, the functional single-layer film 360 according to embodiments can simultaneously improve the anti-reflection, anti-fingerprint, antibacterial, light transmittance, and visibility characteristics.

In addition, when FIG. 10 and FIG. 11 are compared with FIG. 9A and FIG. 9B, the functional single-layer film 360 according to embodiments had high-hardness characteristics (7H to 9H), a greater contact angle (102° to 110°), higher light transmittance (91.89% to 94.37%), lower light reflectance (1.3% to 2.0%), a superior antibacterial function, and reduced haze (hazing) (0.15 to 0.23) compared to the typical protective film 260 of a display device.

When the content of the carbon-containing flakes 380 formed of graphene is less than 0.01%, the hardness, transmission, anti-fingerprint, and antibacterial characteristics are not sufficiently obtained since the content is insufficient. When the content of the carbon-containing flakes 380 is greater than 0.1%, the light transmittance is reduced, and the reflectance increases.

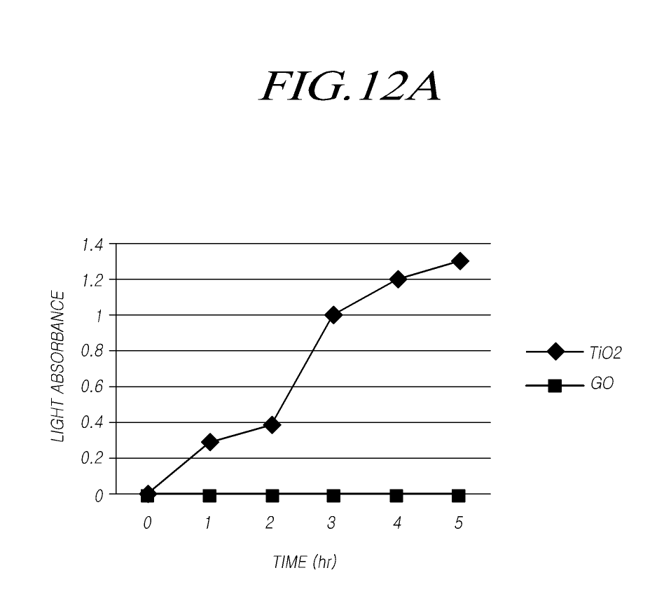

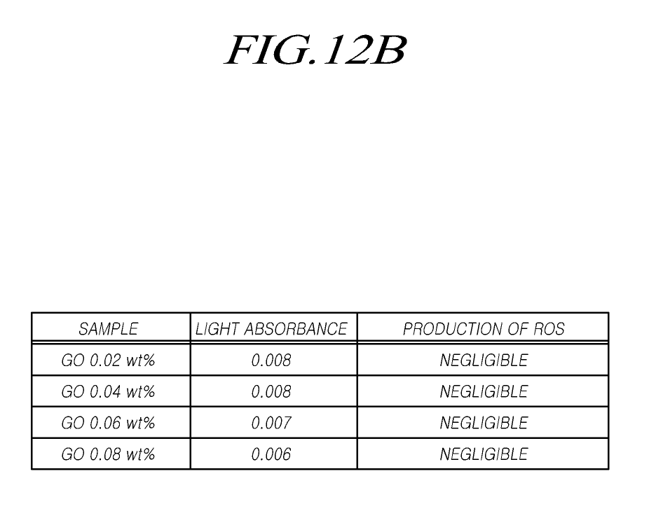

FIG. 12A and FIG. 12B are a graph and table presenting the amounts of reactive oxygen species (ROS) produced from a typical protective film of a display device and a functional single-layer film of a display device according to embodiments of the invention.

First, reactive oxygen species (ROS) refer to oxygen-containing free radicals. ROS are a hazardous agent that has strong activity caused by free radicals, destroys the homeostasis of cells by oxidizing molecules in the cell, and causes irreparable damage to cell tissues.

Referring to FIG. 12A and FIG. 12B, when the antibacterial material is formed of titanium oxide (TiO₂) as in the typical protective film 260 of a display device, harmful ROS are produced. ROS may be produced while TiO₂ is killing bacterial through photolysis.

In contrast, the carbon-containing flakes 380 formed of graphene oxide according to the present invention produced no ROS or a negligible amount of ROS. Therefore, the functional single-layer film 360 can advantageously perform the antibacterial function without producing ROS.

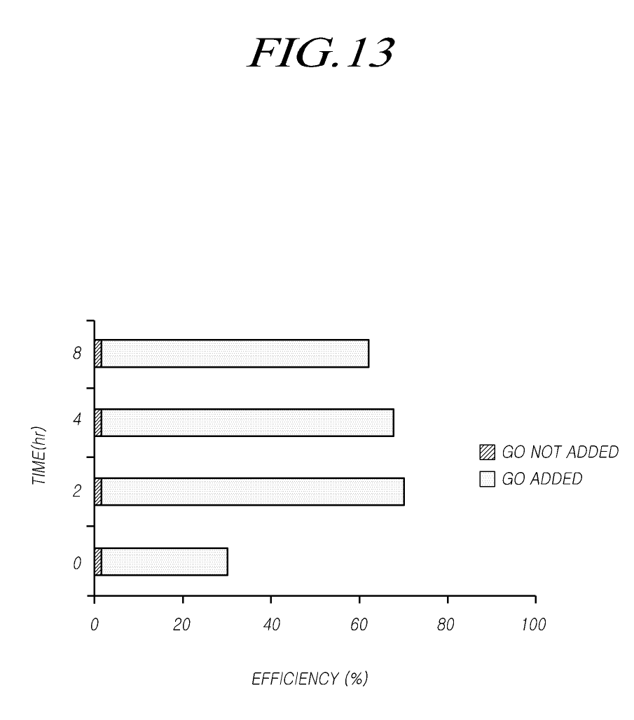

FIG. 13 is a graph illustrating the effects of a functional single-layer film of a display device according to various embodiments against yellow Staphylococcus aureus.

When the functional single-layer film 360 contains the carbon-containing flakes 380 formed of graphene oxide, the functional single-layer film exhibited an antibacterial efficiency of 60% or greater against yellow Staphylococcus aureus. In contrast, when no carbon-containing flakes 380 formed of graphene oxide were contained, no antibacterial characteristics were observed. This shows that the carbon-containing flakes 380 formed of graphene oxide are antibacterial factors.

As set forth above, the functional single-layer film 360 positioned on the cover window 340 of the display device includes the matrix material 366 and the carbon-containing flakes 380 contained in the matrix material 366. The functional single-layer film 360 simultaneously realizes the anti-reflection, anti-fingerprint, antibacterial, transmittance, reflectance, visibility, and reliability characteristics while improving these characteristics. Since the functional single-layer film 360 is formed of a single layer, the number of process steps, the time required for processing, and manufacturing costs are reduced.

Although various embodiments have been described up to now with reference to the accompanying drawings, the present invention is not limited to thereto.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. A term ordinarily used like that defined by a dictionary shall be construed that it has a meaning equal to that in the context of a related description, and shall not be construed in an ideal or excessively formal meaning unless it is clearly defined in the present specification.

Although the embodiments of the present invention have been described for illustrative purposes, those skilled in the art will appreciate that various modifications, additions and substitutions are possible, without departing from the scope and spirit of the invention. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A functional single-layer film comprising:
a matrix material; and
carbon-containing flakes contained in the matrix material,
wherein a content of the carbon-containing flakes ranges from 0.01% to 0.1% by weight.

2. The functional single-layer film as claimed in claim 1,
wherein the carbon-containing flakes comprise at least one type of flakes selected from the group consisting of graphene flakes, graphene oxide flakes, and reduced graphene oxide flakes.

3. The functional single-layer film as claimed in claim 1,
wherein a reflectance of the carbon-containing flakes is greater than a reflectance of the matrix material.

4. The functional single-layer film as claimed in claim 1,
wherein the carbon-containing flakes scatter light entering from an outside.

5. The functional single-layer film as claimed in claim 1,
wherein the matrix material comprises a polymer resin.

6. The functional single-layer film as claimed in claim 1,
wherein the carbon-containing flakes are uniformly dispersed in the matrix material.

7. The functional single-layer film as claimed in claim 1,
wherein the matrix material further comprises a hydrophobic material.

8. A display device comprising:
a display panel;
a cover window positioned on the display panel; and
a functional single-layer film positioned on the cover window, wherein the functional single-layer film comprises a matrix material and carbon-containing flakes contained in the matrix material, a content of the carbon-containing flakes ranging from 0.01% to 0.1% by weight of the functional single-layer film.

9. The display device as claimed in claim 8,
wherein the carbon-containing flakes comprise at least one type of flakes selected from the group consisting of graphene flakes, graphene oxide flakes, and reduced graphene oxide flakes.

10. The display device as claimed in claim 8, further comprising a touchscreen panel positioned between the display panel and the cover window.

11. The display device as claimed in claim 8, further comprising a touchscreen panel disposed inside the display panel.

12. A display device comprising:
a base layer; and
a functional single-layer film positioned on the base layer,
wherein the functional single-layer film comprises a matrix material and carbon-containing flakes contained in the matrix material.

13. The display device as claimed in claim 12,
wherein a content of the carbon-containing flakes ranges from 0.01% to 0.1% by weight of the functional single-layer film.

14. The display device as claimed in claim 12,
wherein the carbon-containing flakes comprise at least one type of flakes selected from the group consisting of graphene flakes, graphene oxide flakes, and reduced graphene oxide flakes.

15. The display device as claimed in claim 12,
wherein the base layer comprises one selected from the group consisting of a display panel, a touchscreen panel and a cover window.
